(19) United States
(12) Patent Application Publication
(10) Pub. No.: US 2026/0307289 A1
(43) Pub. Date: Oct. 8, 2026

(54) Handheld work apparatus and method for operating a handheld work apparatus

(71) Applicant: Andreas Stihl AG & Co. KG, Waiblingen (DE)

(72) Inventors: Claus Naegele, Stuttgart (DE); Philipp Harjung, Schorndorf (DE)

(73) Assignee: Andreas Stihl AG & Co. KG, Waiblingen (DE)

(21) Appl. No.: 19/570,613

(22) Filed: Mar. 18, 2026

(30) Foreign Application Priority Data
Mar. 20, 2025 (DE) 102025110800.5

(51) Int. Cl. B27B 17/08; B27B 17/00; B27B 17/02

(52) U.S. Cl. CPC B27B 17/083; B27B 17/0008; B27B 17/02

(57) ABSTRACT

A handheld work apparatus includes a base body, a tool on the base body, a motor for driving the tool, a handle area for manually holding and guiding the apparatus, and a hand protection device for protecting a hand from the tool. The hand protection device is movable relative to the base body between a position farther from the tool and a position closer to the tool. A motion sensor measures a movement value characterizing movement of the base body. The apparatus brakes the motor and/or the tool when the movement value exceeds a threshold. The threshold is changeable depending on the position of the hand protection device, with a higher threshold assigned to the farther position and a lower threshold assigned to the closer position.

### CROSS-REFERENCE TO RELATED APPLICATION

This application claims the benefit of German Patent Application No. 102025110800.5, filed Mar. 20, 2025, the content of which is incorporated in its entirety.

### TECHNICAL FIELD

The disclosure relates to handheld work apparatuses having driven tools, and more particularly to handheld work apparatuses configured to brake a motor and/or a tool based on movement of the apparatus. The disclosure also relates to methods for operating such handheld work apparatuses.

### BACKGROUND

A generic handheld work apparatus comprises a motion sensor for measuring a movement value. The movement value characterises a movement of the base body of the handheld work apparatus. If the movement value is above a threshold, the motor and/or the tool of the handheld work apparatus is braked using a braking method. If the tool comes into contact with an external object, this can lead to a recoil event. In particular, if the tool is braked suddenly due to the contact with the external object, it can lead to a reaction, in particular a recoil, of the tool. The tool, and with the tool also the base body of the work apparatus, is accelerated counter to its rotational direction. It is standard industry practice for a recoil event of this kind to be referred to as kickback. Ideally, the threshold is chosen such that, in the case of such a recoil event, the movement value, by which the movement of the base body is characterised, is above the threshold. Due to the braking of the motor and/or the tool using the braking method triggered by the threshold being exceeded, the tool comes quickly to a standstill. Thus, this can minimise a danger to the operator due to the tool, which is driven by the motor. If the threshold is low, a braking method may be triggered unintentionally. If the threshold is too high, it can take longer for the braking method to be initiated.

### SUMMARY

An object of the disclosure is to further improve a handheld work apparatus such that it can be easily ensured that a braking method for braking the motor and/or the tool is triggered neither too early nor too late. This object is achieved by a handheld work apparatus as disclosed herein.

A further object of the disclosure is to improve a method for operating a handheld work apparatus such that it can be easily ensured that a braking method for braking the motor and/or the tool, in particular in response to a recoil event, is triggered neither too early nor too late. This object is achieved by a method as disclosed herein.

The handheld work apparatus comprises a tool and a motor for driving the tool. In particular, the tool can be rotationally driven. In particular, the tool, in particular part of the tool, travels rotationally. The work apparatus comprises a handle area for holding and guiding the apparatus by hand. The work apparatus comprises, in particular, a front handle and a rear handle. The front handle is located closer to the tool than the rear handle. In particular, the handle area for holding and guiding the work apparatus by hand is formed by the front handle. The work apparatus comprises a hand protection device. The hand protection device is provided to protect the hand from the tool. In particular, the hand protection device is functionally located between the tool and the handle area for holding and guiding the work apparatus by hand. The hand protection device can be brought into at least two positions relative to the base body. The at least two positions of the hand protection device comprise a far-from-the-tool position and a close-to-the-tool position. In the close-to-the-tool position, the hand protection device, in particular a section of the hand protection device, is located closer to the tool than in the far-from-the-tool position.

If the driven tool comes into contact with an external object, it can lead to a reaction of the tool. Such a reaction can be a recoil of the tool. In the event of contact of the driven tool with an external object, reaction forces may act. Recoil is one of the most commonly occurring reaction forces. In the event of a recoil, the tool, in particular the base body of the handheld work apparatus, in particular the handheld work apparatus, is thrust suddenly and uncontrollably towards the user. It is standard industry practice for this process to be also referred to as kickback. It may pose a danger to the user. A recoil occurs if, for example, the driven tool is jammed or is braked sharply due to frictional contact with a fixed object.

In particular, the hand protection device is arranged such that, when the hand is placed on the handle area and in the event of a recoil event, the base body moves relative to the hand in such a way that the hand protection device is brought closer to the hand and, when it comes into contact with the hand, it is brought from the far-from-the-tool position into the close-to-the-tool position. In particular, the handheld work apparatus is designed in such a way that, in the event of a recoil event, the hand protection device is moved from the far-from-the-tool position into the close-to-the-tool position due to its inertia. In particular, the hand protection device is moved towards the tool in the close-to-the-tool position rather than the far-from-the-tool position, in particular at least partially. In particular, the hand protection device is pivoted towards the tool in the close-to-the-tool position rather than the far-from-the-tool position, in particular at least partially.

In particular, the handle area is tube-shaped for holding and guiding the work apparatus by hand. In particular, the handle area is formed from a handle tube, in particular a loop handle. In particular, the handle area can be grasped with the hand. In particular, the handle area has a longitudinal axis, about which the base body is pivoted in the event of a recoil event, in particular if the work apparatus is held with one hand on the handle area. In particular, the handle area, in particular the handle tube, is connected to the base body. In particular, the hand protection device is a hand protection loop. In particular, the hand protection device is located on the base body; in particular, the hand protection device can be pivoted relative to the base body. In particular, the hand protection device can be pivoted from the far-from-the-tool position into the close-to-the-tool position, in particular.

The handheld work apparatus comprises a motion sensor. The motion sensor is located, in particular, on or in the base body. The motion sensor serves to measure a movement value. The movement value characterises a movement of the base body of the work apparatus. The work apparatus is designed such that if the movement value is above a threshold, the motor and/or the tool is braked using a braking method. In this way, a recoil event can be detected easily using the motion sensor. A recoil event is more likely to occur if the movement value, measured using the motion sensor, is above the threshold. Due to the fact that the motor and/or the tool is braked using a braking method when the movement value is above the threshold, the danger to the user in the event of a recoil event is reduced.

The value of the threshold can be changed depending on the position of the hand protection device. The far-from-the-tool position is assigned a large value for the threshold. The close-to-the-tool position is assigned a small value for the threshold. The value of the threshold can be changed easily because the value of the threshold can be changed depending on the position of the hand protection device. The hand protection device is not only used to protect the hand from the tool, but also to adjust the value of the threshold. This allows for a very simple construction of the handheld work apparatus and reduces the number of necessary components. The value of the threshold can easily be changed.

By assigning a large value for the threshold to the far-from-the-tool position, premature triggering of the braking method for the braking of the motor and/or the tool can be avoided. Only when the hand protection device is moved from the far-from-the-tool position into the close-to-the-tool position, as a result of a recoil event in particular, is the braking method triggered quickly, as the close-to-the-tool position of the hand protection device is associated with the small value for the threshold. Thus, if the hand protection device is in the close-to-the-tool position, the small threshold is exceeded even when a small movement value is measured. Therefore, a small movement, especially one with minor acceleration, is enough to trigger the braking method for the braking of the motor and/or the tool. This ensures that the braking method is triggered neither too early nor too late. An additional increase in safety results from the fact that, even if the hand protection device remains or is in the far-from-the-tool position, in the event of a recoil in particular, the braking method for the braking of the motor and/or the tool can be triggered, namely when the large threshold is exceeded.

When the movement value is above the threshold, in particular, the motor and/or the tool is braked with maximum intensity of the braking method. This applies both when the hand protection device is in the far-from-the-tool position and also when the hand protection device is in the close-to-the-tool position. When the movement value is above the small threshold, and also when the movement value is above the large threshold, the motor and/or the tool is braked with maximum intensity of the braking method. Since the motor and/or the tool is braked with maximum intensity of the braking method, the danger to the operator, in particular in the event of a recoil event, is minimised. The motor and/or the tool are braked as quickly as possible; in particular, they are brought to a standstill as quickly as possible.

The motor is an electric motor, in particular. The braking method is an electric braking method, in particular. In particular, the electric motor is braked electrically if the movement value is above the threshold. Thus, the braking method can be triggered and/or executed particularly quickly. Consequently, sharp braking is possible. In particular, the electric motor has at least two terminals for connection to an electrical energy supply. In particular, the at least two terminals are short-circuited to brake the electric motor if the movement value is above the threshold. This applies for both the small and the large threshold. The short-circuiting of the at least two terminals of the electric motor is also known as short-circuit braking.

In particular, the work apparatus is designed such that the at least two terminals of the electric motor are not short-circuited with each other when the movement value is under the threshold.

In particular, the work apparatus is free of a mechanical brake for the motor and/or the tool.

In an advantageous development, the work apparatus is designed such that if the hand protection device is in the close-to-the-tool position and, simultaneously, the movement value corresponds at most to the threshold, the motor and/or the tool is braked with a reduced intensity, which is smaller than the maximum intensity of the braking method. Thus, the hand protection device can be used as a trigger for braking the motor and/or the tool with reduced intensity. If the hand protection device is in the close-to-the-tool position, the motor and/or the tool is braked in any case. If the movement value corresponds at most to the threshold, the braking method occurs with reduced intensity, and if the movement value is over the threshold, the braking method occurs with maximum intensity. Thus, the operator can manually move the hand protection device from the far-from-the-tool position to the close-to-the-tool position once they have finished using the work apparatus and trigger braking of the motor and/or the tool. Thus, the running-down process of the tool can be shortened. Hence, the danger to the operator can be reduced or minimised. If the operator moves the handheld work apparatus rapidly while the tool is running down and the hand protection device is in the close-to-the-tool position, the measured movement value exceeds the threshold, causing the motor and/or the tool to be braked with maximum intensity of the braking method. If the operator moves the work apparatus while the tool is running down, the danger to the operator can potentially be greater. Due to the fact that, during rapid movement, the threshold is exceeded, and braking occurs with maximum intensity of the braking method, the danger to the operator is minimised. If, however, the work apparatus is not moved, the motor and/or the tool can be braked with reduced intensity. This is gentler for the operator. They are subjected to less stress due to the lower acceleration. The same applies for the work apparatus overall. Sharp braking is only necessary if the operator may be exposed to increased danger due to a movement of the work apparatus.

In particular, the work apparatus is designed such that the motor, designed as an electric motor, is braked electrically, in particular recuperatively, if the hand protection device is in the close-to-the-tool position and, simultaneously, the movement value corresponds at most to the threshold. Thus, energy can be recovered during braking.

The work apparatus comprises, in particular, a rechargeable battery for supplying the electric motor with electrical energy. The work apparatus, in particular, is designed such that the rechargeable battery is charged during the recuperative braking of the electric motor.

If the work apparatus is not moved and the hand protection device is in the close-to-the-tool position, the energy gained during braking can be used to charge the rechargeable battery. However, if in this situation the work apparatus is moved too rapidly, braking no longer occurs recuperatively, but rather with maximum intensity of the braking method, in particular the electric braking method. The short-circuit braking of the electric motor is then used.

The motion sensor is a gyro sensor or an acceleration sensor, in particular.

Therefore, the movement value is an angular velocity or an acceleration. The motion sensor measures, in particular, the movement of the base body with respect to at least one axis, in particular exactly one axis, and in particular with respect to at least two axes. In order to detect a recoil event, it is generally sufficient to detect the movement of a base body with respect to one axis, in particular with respect to a pivoting movement about one axis, which is substantially parallel to the motor axis of rotation. If the motion sensor is a gyro sensor, in particular, measuring the movement of the base body with respect to a single axis is sufficient to detect a recoil event. If the motion sensor is an acceleration sensor, it can be useful to measure the movement of the base body with respect to at least two, in particular with respect to exactly two axes, in order to detect a recoil event. In this case, a plane is spanned by the at least two axes, which run transversely, in particular perpendicularly to the rotational axis of the motor. It can also be provided that the motion sensor measures the movement of the base body with respect to six axes. This can be particularly advantageous if the movement of the base body is to be detected when the hand protection device is in the close-to-the-tool position.

In particular, the close-to-the-tool position of the hand protection device is assigned a threshold of less than 100°/s, in particular of less than 60°/s.

In particular, the far-from-the-tool position of the hand protection device is assigned a threshold of 200°/s to 500°/s, in particular of 250°/s to 400°/s.

In the method for operating a handheld work apparatus, which is designed such that the motor and/or the tool is braked if the movement value is above a threshold, it is provided that the value of the threshold is changed depending on the position of the hand protection device, and that, when transitioning from a far-from-the-tool position of the hand protection device to a close-to-the-tool position of the hand protection device, the value of the threshold is reduced. This is associated with the advantages described for the handheld work apparatus. A further development of the method with the features of the above-described handheld work apparatus is possible. These further developments are associated with the advantages described for the handheld work apparatus.

### BRIEF DESCRIPTION OF THE DRAWINGS

An exemplary embodiment of the invention is explained below with reference to the drawings, which show:

FIG. 1: a schematic side view of a work apparatus designed as a motor chain saw with a hand protection device, which is in the far-from-the-tool position,

FIG. 2: the schematic side view from FIG. 1, wherein the hand protection device is in the close-to-the-tool position,

FIG. 3: a schematic sectional view of a section through the work apparatus shown in FIG. 1, wherein the sectional plane is perpendicular to the direction of the rotational axis of the motor,

FIG. 4: a flowchart, showing the operation of the handheld work apparatus depending on the position of the hand protection device and the movement value.

### DETAILED DESCRIPTION

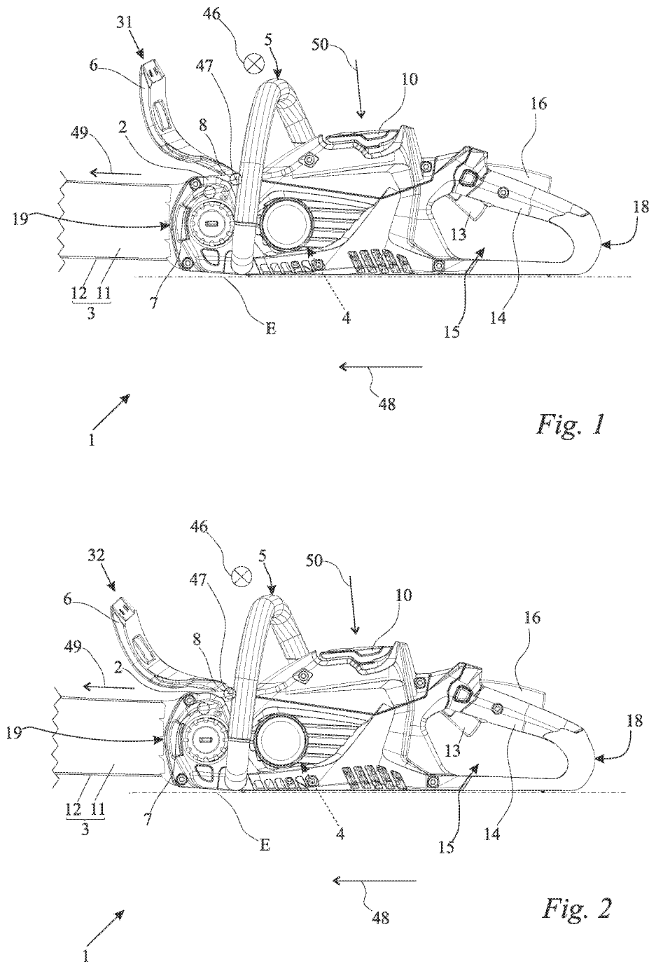

FIGS. 1 to 4 relate to a handheld work apparatus 1. In the exemplary embodiment, the handheld work apparatus 1 is a motor chain saw. The handheld work apparatus can, however, also be a cut-off machine, a brush cutter, a wood cutter, or similar work apparatus with rotating tool. The work apparatus 1 is handheld, in particular hand-carried. The work apparatus 1 is intended for handheld operation. The work apparatus 1 is portable. The work apparatus 1 is carried and held by the operator during its intended operation. During operation of the work apparatus 1, it is not necessary for the work apparatus 1 to be braced by a device or workpiece.

The work apparatus 1 has a base body 2, as shown in FIGS. 1 to 3. The work apparatus 1 comprises a tool 3. The tool 3 is located on the base body 2. The tool 3 is fixed to the base body 2. The tool 3 is a cutting tool, in particular. In the exemplary embodiment, the tool 3 is formed by a guide bar 11 and a chainsaw chain 12. The chainsaw chain 12 can revolve on the guide bar 11. In an alternative embodiment, the tool can also be a cutting wheel, a saw blade or a rotating blade.

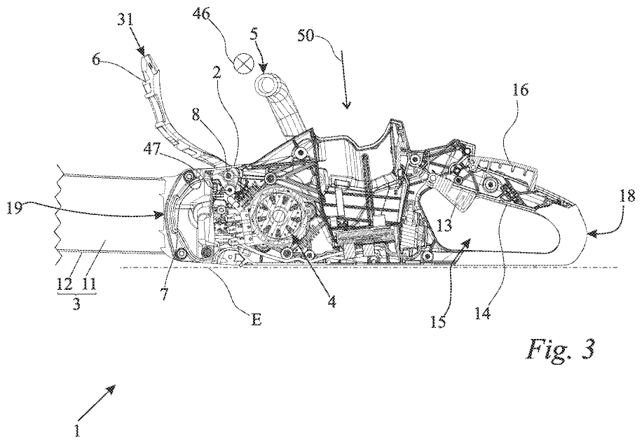

The work apparatus 1 comprises a motor 4. The motor 4 is located inside the base body 2, as shown in FIG. 3. The motor 4 serves to drive the tool 3, in particular the chainsaw chain 12. The base body 2 comprises a housing, inside which the motor 4 is located. The housing delimits the base body 2 to the outside. In the exemplary embodiment, the motor 4 is designed as an electric motor. In an alternative embodiment, the motor can also be designed as an internal combustion engine. In the exemplary embodiment, the motor 4 is a direct current motor, in particular a brushless direct current motor. Very particularly, the motor 4 is an electronically commutated motor. The electronically commutated motor is also known as an EC motor. In this, an electronic control system converts the direct current into an appropriate three-phase current. The three-phase winding is controlled by a suitable circuit in such a way that it generates a travelling electromagnetic field, which in turn drives the motor. The EC motor is three-phase, in particular.

The work apparatus 1 comprises a rechargeable battery 10, as shown in FIGS. 1 and 2. The rechargeable battery 10 serves to supply the motor 3 with electrical energy. The rechargeable battery 10 is housed in a battery compartment of the base body 2, in particular of the housing of the base body 2. The rechargeable battery 10 can be inserted into the battery compartment in an insertion direction 50. The battery compartment completely encloses the rechargeable battery 10 in the rotational direction around the insertion direction 50. In an alternative embodiment, it can also be provided that the motor 4, designed as an electric motor, is supplied with electrical energy from a public power grid. In this case, the handheld work apparatus 1 comprises a power cable. In the exemplary embodiment, the work apparatus 1 is cableless.

The motor 4 serves to drive the tool 3. The tool 3, in particular the chainsaw chain 12, is rotationally driven. The motor 4 drives the tool 3 in operation in a rotational direction 49 marked in FIG. 1. The rotational direction 49 revolves about the axis of rotation of the motor 4. In the exemplary embodiment, a sprocket, not shown, is provided, for transmitting the torque of the motor 4 to the tool 3, in particular the chainsaw chain 12. The sprocket engages in the links of the chainsaw chain 12. Using the sprocket, the chainsaw chain 12 can be accelerated or braked. The sprocket is located on a shaft of the motor 4.

As shown in FIGS. 1 to 3, the base body 2 extends from a rear end 18 to a front end 19. The rear end 18 of the base body 2 faces the operator during operation. The front end 19 of the base body 2 faces away from the operator during operation. The work apparatus 1 comprises a rear handle 14. The rear handle 14 forms the rear end 18. The rear handle 14 is formed by the housing of the base body 2. The base body 2 has a handle opening 15. The handle opening 15 fully penetrates the base body 2, in particular the housing of the base body 2. The handle opening 15 abuts the rear handle 14. When grasping the rear handle 14, the operator can reach through the handle opening 15 with their fingers. A control element 13 is located on the rear handle 14. The control element 13 serves to control the motor 4. The control element 13 is formed as an operating lever in the exemplary embodiment. The control element 13 protrudes, in particular, from the rear handle 14. The work apparatus 1 comprises a blocking element 16, in particular. The blocking element 16 blocks the control element 13 in a blocking position and releases the control element 13 for operation in a release position. The blocking element 16 preferably designed as a blocking lever. The control element 13 can be activated by the operator grasping the rear handle 14.

As shown in FIGS. 1 to 3, the work apparatus 1 comprises a handle area 5. The handle area 5 is located on a handle tube. The handle tube is located on the base body 2, in particular it is fixed thereon. The handle tube encompasses the base body 2. The handle area 5 is also known as the front handle. The handle area 5 is located closer to the front end 19 of the base body 2 than the rear handle 14. The base body 2 extends in a longitudinal direction 48 from the rear end 18 to the front end 19. The handle area 5 is located between the rear handle 14 and the front end 19, relative to the longitudinal direction 48 of the base body 2. The handle area 5 is located above the base body 2. This is particularly true when the work apparatus 1 is placed on the horizontal plane E, as shown in FIG. 1. The handle area 5 is located in the uppermost section of the handle tube. The handle area 5 extends longitudinally along an extension direction 46. The extension direction 46 extends transversely, in particular perpendicular to the longitudinal direction 48. The extension direction 46 extends in particular parallel to the direction of the axis of rotation of the motor 4.

The handle area 5 is used for holding and guiding the work apparatus 1 by hand. The work apparatus 1, in particular, can be carried by hand by grasping the handle area 5. During operation of the work apparatus 1, one hand rests on the rear handle 14 and the other hand on the handle area 5. In particular, the weight of the work apparatus 1 can be braced and/or absorbed by the operator at the handle area 5. The work apparatus can be aligned using the rear handle 14 and, simultaneously, the motor 4 can be controlled using the control element 13.

The tool 3 protrudes beyond the base body 2 at the front end 19 of the base body 2 in the longitudinal direction 48. The handheld work apparatus 1 comprises a hand protection device 6. The hand protection device 6 serves to protect the hand from the tool 3. The hand protection device 6 serves, in particular, to protect the hand which rests against the handle area 5. The hand protection device 6 is functionally located between the handle area 5 and the tool 3, in particular the chainsaw chain 12. In particular, the hand protection device 6 is located between the handle area 5 and the part of the tool 3, in particular the chainsaw chain 12, which protrudes beyond the base body 2.

The hand protection device 6 can be brought into at least two positions 31, 32 relative to the base body 2. The hand protection device 6 is shown in a far-from-the-tool position 31 in FIG. 1. The hand protection device 6 is shown in a close-to-the-tool position 32 in FIG. 2. In the far-from-the-tool position 31, the hand protection device 6 is further away from the tool 3, in particular from the chainsaw chain 12. In the close-to-the-tool position 32, the hand protection device 6 is closer to the tool 3, in particular closer to the chainsaw chain 12, than in the far-from-the-tool position 31. This is particularly true for a part of the hand protection device 6. This part is the section of the hand protection device 6 which is furthest from the base body 2. In the close-to-the-tool position 32, the hand protection device 6, particularly the part of the hand protection device 6, is further away from the handle area 5 than in the far-from-the-tool position 31. In the close-to-the-tool position 32, the hand protection device 6 is located further forward with respect to the longitudinal direction 48 than in the far-from-the-tool position 31.

The hand protection device 6 is located pivotally on the base body 2. The hand protection device 6 is pivotable about a pivot axis 47. The pivot axis 47 extends transversely, in particular perpendicular to the longitudinal direction 48. The longitudinal direction 48 extends parallel to the horizontal plane E, in particular, if the work apparatus 1 is placed thereon. The pivot axis 47 extends parallel, in particular, to the horizontal plane E if the work apparatus 1 is placed thereon.

In the far-from-the-tool position 31, the hand protection device 6 is pivoted to the rear with respect to the longitudinal direction 48. In the close-to-the-tool position 32, the hand protection device 6 is pivoted to the front with respect to the longitudinal direction 48. In the close-to-the-tool position 32, the hand protection device 6 protrudes further beyond the base body 2, with respect to the longitudinal direction 48, than in the far-from-the-tool position 31. The far-from-the-tool position 31 and the close-to-the-tool position 32 are end positions of the hand protection device 6. The hand protection device 6 can only be pivoted between the far-from-the-tool position 31 and the close-to-the-tool position 32. The far-from-the-tool position 31 and the close-to-the-tool position 32 are located at an angular distance of less than 90°, in particular of less than 70°, in particular of less than 45°, in particular of less than 30° from each other, with respect to the pivot axis 47. In particular, the angular distance between the far-from-the-tool position 31 and the close-to-the-tool position 32 is at least 5°, in particular at least 10°. The part or point of the hand protection device 6 which is furthest away from the base body 2 can serve as a reference point for the angle measurement. The handle area 5 and the far-from-the-tool position 31 are located at an angular distance of at least 30°, in particular of at least 40° from each other, with respect to the pivot axis 47. The handle area 5 and the far-from-the-tool position 31 are located at an angular distance of at most 70°, in particularly of at most 60° from each other, with respect to the pivot axis 47.

In the exemplary embodiment, the hand protection device 6 is a hand protection loop.

The handheld work apparatus 1 comprises a position detector 8, as shown schematically in FIGS. 1 to 3. The position detector 8 serves to detect the position of the hand protection device 6. Using the position detector 8, it can be detected whether the hand protection device 6 is in the far-from-the-tool position 31 or in the close-to-the-tool position 32. The position detector 8 can in particular be a contact switch, a micro switch, or a similar switch. It can also be provided that the position detector 8 is a hall sensor and that a magnet which interacts with the hall sensor is located on the hand protection device 6. It can also be provided that the position detector 8 is a light barrier. The position detector 8 generates a signal.

The handheld work apparatus 1 comprises, in particular, a control unit (not shown).

The signal generated by the position detector 8 is transmitted to the control unit, in particular wirelessly. It can, however, also be provided that the signal is transmitted using a cable.

The handheld work apparatus 1 comprises a motion sensor 7. The motion sensor 7 is schematically drawn in FIGS. 1 to 3 with a dotted line. The motion sensor 7 serves to measure a movement value. The movement value is a measured value which characterises a movement of the base body 2. The movement value in particular specifies a measure of the intensity of the movement of the base body 2. The movement value can be a velocity, in particular an angular velocity. It can, however, also be provided that the movement value is an acceleration, in particular an angular acceleration. The motion sensor 7 measures and characterises the movement of the base body 2 in space. The motion sensor 7 is a gyro sensor or a gyroscope, in particular. The gyroscope is also known as a rotation rate sensor. The angular velocity can be measured with a gyroscope. A motion sensor 7 can, however, also be an acceleration sensor. The motion sensor 7 measures the movement of the base body 2 with respect to at least one, in particular exactly one, axis. In particular, the motion sensor 7 measures the movement of the base body 2 with respect to at least two axes. In particular, the motion sensor 7 designed as a gyroscope measures the movement of the base body 2 with respect to at least one, in particular exactly one, axis. The measurement of a rotational movement about a longitudinal axis of the handle area 5 is sufficient to characterise, in particular to detect, a recoil event. The longitudinal axis of the handle area 5 extends along a direction of extension 46. The longitudinal axis of the handle area 5 runs, in particular, parallel to the axis of rotation of the motor 4. In a motion sensor 7 designed as an acceleration sensor, it is in particular provided that the motion sensor 7 measures the movement of the base body 2 with respect to at least two axes. These two axes span a plane, which runs transversely, in particular perpendicularly, to the extension direction 46 of the handle area 5. Due to the fact that the acceleration is measured with respect to at least two axes, a pivoting movement or rotational movement about the longitudinal axis of the handle area 5 can be characterised, in particular detected. However, it can also be provided that the motion sensor 7 measures the movement of the base body 2 with respect to six axes.

The work apparatus 1 is designed such that the motor 4 and/or of the tool 3 is braked using a braking method if the movement value is over a threshold. In particular, the movement value is continuously determined using the motion sensor 7 during operation of the handheld work apparatus 1. As soon as the determined movement value rises above the threshold, the braking method is initiated. Thus, if a recoil event occurs, because the driven tool 3 hits or jams a fixed object, and the tool 3, in particular the base body 2, is moved, in particular accelerated, in the direction away from the object and in the direction towards the user as a result of the recoil event, the motion sensor 7 measures a movement value which is above the threshold. As a result, the motor 4 and/or the tool 3 is braked using the braking method.

The movement values measured by the motion sensor 7 are supplied to the control unit. The threshold is stored in the control unit. In the control unit, the movement value is compared with the threshold. As soon as the movement value is over the threshold, the control unit triggers the braking method.

The value of the threshold can be changed depending on the position 31, 32 of the hand protection device 6. The far-from-the-tool position 31 is assigned a large value for the threshold. The close-to-the-tool position 32 is assigned a small value for the threshold. In the far-from-the-tool position 31, the threshold is also known as the far-from-the-tool threshold or as the first threshold. In the close-to-the-tool position 32, the threshold is also known as the close-to-the-tool threshold or as the second threshold. The close-to-the-tool threshold is smaller than the far-from-the-tool threshold.

If the hand protection device 6 is in the far-from-the-tool position 31, the control unit compares the movement value measured by the motion sensor 7 with the larger, far-from-the-tool threshold. If the hand protection 6 is in the close-to-the-tool position 32, the control unit compares the movement value measured by the motion sensor 7 with the smaller, close-to-the-tool threshold. If the hand protection device 6 is in the far-from-the-tool position 31 and the movement value is above the far-from-the-tool threshold, the motor 4 and/or the tool 3 is braked using the braking method. If the hand protection device 6 is in the close-to-the-tool position 32 and the movement value is above the close-to-the-tool threshold, the motor 4 and/or the tool 3 is braked using the braking method.

The control unit receives the signal from the position sensor 8 and decides, based on the signal, whether the hand protection device 6 is in the close-to-the-tool position 32 or in the far-from-the-tool position 31 and then applies the corresponding threshold. The motion sensor 7 transmits the movement value to the control unit in the form of a signal. The corresponding signal is transmitted wirelessly, in particular. It can, however, also be provided that the corresponding signal is transmitted using a cable. The control unit compares the current movement value with the current threshold.

If the movement value is above the threshold (above the far-from-the-tool threshold or above the close-to-the-tool threshold), the motor 4 and/or the tool 3 is braked with maximum intensity of the braking method. The braking method is an electric braking method, in particular.

In the exemplary embodiment, the motor 4 formed as an electric motor is braked electrically if the movement value is above the threshold. In particular, the electric motor has at least two terminals for connection to an electrical energy supply, which are short-circuited to brake the electric motor if the movement value is above the threshold. This part of the braking method is sometimes known as electric short-circuit braking. In addition to short-circuit braking, the braking method comprises a further type of electrical braking with reduced intensity. The reduced intensity is smaller than the maximal intensity of the braking method. At maximum intensity of the braking method, braking occurs with short-circuit braking.

The work apparatus 1 is designed such that the at least two terminals of the electric motor are not short-circuited with each other when the movement value is under the threshold. If the movement value is under the threshold (under the far-from-the-tool threshold or under the close-to-the-tool threshold), the motor 4 and/or the tool 3 can never be braked with maximum intensity of the braking method. The maximum intensity of the braking method is only reached if the short-circuit braking of the electric motor is activated.

The work apparatus 1 is designed such that when the hand protection device 6 is in the close-to-the-tool position 32 and, simultaneously, the movement value corresponds at most to the threshold, the motor 4 and/or the tool 3 is braked with a reduced intensity. In particular, the work apparatus is designed such that the motor 4 formed as an electric motor is braked electrically, in particular recuperatively, if the hand protection device 6 is in the close-to-the-tool position 32 and, simultaneously, the movement value corresponds at most to the threshold. In recuperative braking, the kinetic energy of the tool 3 is converted into electrical energy. The motor 4 formed as an electric motor is used as a generator. Using this generator, the kinetic energy of the tool 3, in particular the chainsaw chain 12, can be converted into electrical energy. In the exemplary embodiment, the electrical energy generated in this way is stored in the rechargeable battery 10. In this way, the rechargeable battery 10 is charged during the recuperative braking. Recuperative braking is also known as regenerative braking. The braking method comprises both short-circuit braking as well as recuperative braking. As soon as the movement value is above the threshold, braking is carried out using short-circuit braking.

The work apparatus 1 is designed such that the motor 4 is operated without braking if the hand protection device 6 is in the far-from-the-tool position 31 and the movement value corresponds at most to the threshold. If the movement value corresponds at most to the threshold, the motor 4 is operated either unbraked or recuperatively braked, depending on the position 31, 32 of the hand protection device 6. In the far-from-the-tool position 31, the motor 4 is operated unbraked and in the close-to-the-tool position 32, the motor 4 is recuperatively braked if the movement value corresponds at most to the threshold. In the exemplary embodiment, this applies for all movement values which are smaller than the threshold.

In the case where the motion sensor 7 is a gyroscope or rotation rate sensor, the close-to-the-tool threshold is less than 100°/s, in particular less than 60°/s. This angular velocity refers, in particular, to a movement about the longitudinal axis of the handle area 5. The motion sensor 7 measures, in particular, a movement of the base body 2, which corresponds to a rotational movement about the longitudinal axis of the handle area 5.

In the exemplary embodiments, the far-from-the-tool threshold is from 200°/s to 500°/s, in particular from 250°/s to 400°/s.

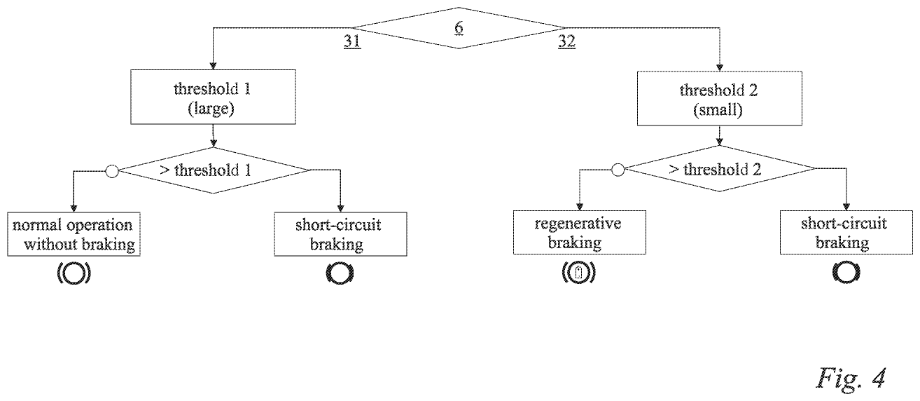

FIG. 4 shows a flowchart of the method for operating the handheld work apparatus 1. Firstly, the position of the hand protection device 6 is requested. If the hand protection device 6 is in the far-from-the-tool position 31, the value of the threshold is large. In this case, the threshold is the far-from-the-tool threshold. This threshold is referred to as threshold 1 in the diagram. In the next step, as long as the hand protection device 6 is in the far-from-the-tool position 31, the movement value measured by the motion sensor 7 is compared with the far-from-the-tool threshold, in particular the threshold 1. If the movement value is larger than the far-from-the-tool threshold, in particular the threshold 1, the motor 4 and/or the tool 3 is braked with maximum intensity of the braking method. In the exemplary embodiment, the motor 4 formed as an electric motor is short-circuited and used as a short-circuit brake. If the movement value corresponds at most to the far-from-the-tool threshold, in particular the threshold 1, the motor 4 is operated unbraked, as long as the hand protection device 6 is in the far-from-the-tool position 31.

The value of the threshold is changed depending on the position 31, 32 of the hand protection device 6. If the hand protection device 6 is moved from the far-from-the-tool position 31 into the close-to-the-tool position 32, the value of the threshold is reduced. In the close-to-the-tool position 32, the value of the threshold is smaller than in the far-from-the-tool position 31. In FIG. 4, the close-to-the-tool threshold is referred to as threshold 2. The close-to-the-tool threshold is smaller than the far-from-the-tool threshold. Thus, if the hand protection device 6 is moved into the close-to-the-tool position 32, for example in a recoil event or because the user manually activates it, the threshold corresponds to the close-to-the-tool threshold. The movement values measured by the motion sensor 7 are then compared, in the close-to-the-tool position 32 of the hand protection tool 6, with the smaller, close-to-the-tool threshold. If the movement value in the close-to-the-tool position 32 is larger than the close-to-the-tool threshold, the motor and/or the tool is braked with maximum intensity of the braking method. The contacts of the motor 4 designed as an electric motor are short-circuited. The motor 4, in particular the tool 3, is braked using short-circuit braking.

If the movement value corresponds at most to the close-to-the-tool threshold, the motor 4 and/or the tool 3 is braked with reduced intensity compared to the maximum intensity of the braking method, as long as the hand protection device 6 is in the close-to-the-tool position 32. As shown in FIG. 4, the motor 4 designed as an electric motor is recuperatively braked.

The decisions shown in the flowchart according to FIG. 4 are made, in particular, in the control unit (not shown) of the work apparatus 1. The position of the hand protection device 6 is detected using the position detector 8. The position detector 8 transmits a corresponding signal to the control unit. The transmission can be carried out wirelessly or via a radio link. Depending on the position of the hand protection device 6, different signals are transmitted to the control unit. The signals can differ in type and/or intensity. The control unit receives the signal and, as a result, obtains information about whether the hand protection device 6 is in the far-from-the-tool position 31 or in the close-to-the-tool position 32. Depending on this, the control unit sets the threshold to the far-from-the-tool threshold value, in particular the threshold 1, or to the close-to-the-tool threshold, in particular the threshold 2. The motion sensor 7 measures the movement value and transmits it to the control unit in the form of a wireless or wired signal. The control unit compares the measured movement value with the respective, current threshold. If the hand protection device 6 is in the far-from-the-tool position 31 and the movement value corresponds at most to the threshold, normal operation takes place without braking the motor 4 or the tool 3. If the hand protection device 6 is in the far-from-the-tool position 31 and the movement value is larger than the threshold, the control unit sends a signal to the motor 4, or to corresponding switches, in order to short-circuit the motor 4 and trigger the short-circuit braking.

If the hand protection device 6 is in the close-to-the-tool position 32, the control unit compares the movement value, which corresponds to the signal transmitted by the motion sensor 7 to the control unit, with the close-to-the-tool threshold present in the close-to-the-tool position 32. If the movement value corresponds at most to the threshold, the control unit operates the motor 4 as a generator, so that the motor 4 and thus the tool 3 as well are regeneratively braked. If the movement value is above the close-to-the-tool threshold, the control unit sends signals to the motor 4, or to corresponding switches, so that the motor 4 is short-circuited and braked using short-circuit braking.

The hand protection device 6 can be used by the operator as an actuating element of a brake. If the hand protection device 6 is manually moved from the far-from-the-tool position 31 into the close-to-the-tool position 32, the tool 3, in particular the chainsaw chain 12, is braked. Once the work apparatus 1 has finished being used, the hand protection device 6 can be used as a run-out brake, in order to bring the tool 6 to a planned standstill and minimise danger to the user. If the work apparatus 1 is held still during the run-out braking or placed on the ground, the danger to the user is less than if the work apparatus 1 is moved during the run-out braking. By measuring the movement value, it is known whether the work apparatus 1, in particular the base body 2, is in motion during the run-out braking, i.e., when the hand protection device 6 is in the close-to-the-tool position, while the tool 3, in particular the chainsaw chain 12, is rotating. If the movement value is above the close-to-the-tool threshold, in particular the threshold 2, braking occurs with short-circuit braking. If the threshold corresponds at most to the close-to-the-tool threshold, braking can be carried out recuperatively.

As any movement of the work apparatus 1, in particular of the base body 2, in space during the run-out braking can pose a danger to the user, if the hand protection device 6 is in the close-to-the-tool position 32, it is important to detect movements in every spatial direction. If the hand protection device 6 is in the far-from-the-tool position 31, detection of, above all, a recoil event is relevant. In this case, a rotational movement of the work apparatus 1, particularly the base body 2, occurs about a single axis, in particular about the longitudinal axis of the handle area 5. For this reason, the detection of a single movement in the far-from-the-tool position 31 of the hand protection device 6 is particularly relevant.

It can be provided that the motion sensor 7 in the far-from-the-tool position 31 of the hand protection device 6 measures a movement of the base body 2 solely with respect to a single axis. In the close-to-the-tool position 32 of the hand protection device 6, the motion sensor 7 then measures the movement of the base body 2 in this alternative design with respect to at least three axes, in particular, with respect to six axes. In this way, the hand protection device 6 can be a switching element for the number of axes to be measured during the movement detection. In an analogous way, the position 31, 32 of the hand protection device 6 can also decide which measured values of the motion sensor 7 are taken into account during the evaluation, in particular in the control unit.

1.-14. (Canceled)

15. A handheld work apparatus, comprising:
a base body (2);
a tool (3) located on the base body (2);
a motor (4) configured to drive the tool (3);
a handle area (5) configured for holding and guiding the handheld work apparatus (1) by hand;
a hand protection device (6), configured to protect the hand from the tool (3), the hand protection device (6) being movable relative to the base body (2) between at least a far-from-the-tool position (31) and a close-to-the-tool position (32), wherein the hand protection device (6) is located closer to the tool (3) in the close-to-the-tool position (32) than in the far-from-the-tool position (31); and
a motion sensor (7) configured to measure a movement value characterizing movement of the base body (2),
wherein the handheld work apparatus (1) is configured to brake the motor (4) and/or the tool (3) when the movement value exceeds a threshold, and
wherein the threshold has a first threshold value when the hand protection device (6) is in the far-from-the-tool position (31) and a second threshold value when the hand protection device (6) is in the close-to-the-tool position (32), the first threshold value being greater than the second threshold value.

16. The handheld work apparatus according to claim 15,
wherein the handheld work apparatus is configured to brake the motor (4) and/or the tool (3) with a maximum intensity when the movement value exceeds the threshold.

17. The handheld work apparatus according to claim 15,
wherein the motor (4) is an electric motor, and
wherein the electric motor is braked electrically if the movement value is above the threshold.

18. The handheld work apparatus according to claim 17,
wherein the electric motor comprises at least two terminals configured for connection to an electrical energy supply, and
wherein the handheld work apparatus is configured to short-circuit the at least two terminals to brake the electric motor when the movement value exceeds the threshold.

19. The handheld work apparatus according to claim 16,
wherein the handheld work apparatus is configured to brake the motor (4) and/or the tool (3) with a reduced intensity when the hand protection device (6) is in the close-to-the-tool position (32) and the movement value is equal to or less than the threshold, and
wherein the reduced intensity is less than the maximum intensity.

20. The handheld work apparatus according to claim 15,
wherein the motor (4) is an electric motor, and
wherein the handheld work apparatus is configured to electrically brake the electric motor when the hand protection device (6) is in the close-to-the-tool position (32) and the movement value is equal to or less than the threshold.

21. The handheld work apparatus according to claim 15,
wherein the motor (4) is an electric motor, and
wherein the handheld work apparatus is configured to recuperatively brake the electric motor when the hand protection device (6) is in the close-to-the-tool position (32) and the movement value is equal to or less than the threshold.

22. The handheld work apparatus according to claim 15,
wherein the handheld work apparatus is configured to operate the motor (4) without braking when the hand protection device (6) is in the far-from-the-tool position (31) and the movement value is equal to or less than the threshold.

23. The handheld work apparatus according to claim 15,
wherein the motion sensor (7) comprises a gyro sensor or an acceleration sensor.

24. The handheld work apparatus according to claim 23,
wherein the motion sensor (7) is configured to measure movement of the base body (2) with respect to at least one axis.

25. The handheld work apparatus according to claim 23,
wherein the motion sensor (7) is configured to measure movement of the base body (2) with respect to exactly one axis.

26. The handheld work apparatus according to claim 15,
wherein the second threshold value assigned to the close-to-the-tool position (32) is less than 100°/s.

27. The handheld work apparatus according to claim 15,
wherein the first threshold value assigned to the far-from-the-tool position (31) is from 200°/s to 500°/s.

28. A method for operating a handheld work apparatus, the handheld work apparatus (1) comprising a base body (2), a tool (3) located on the base body (2), a motor (4) configured to drive the tool (3), a handle area (5) configured for holding and guiding the handheld work apparatus by hand, a hand protection device (6) configured to protect a hand from the tool (3), and a motion sensor (7), the method comprising:
measuring, using the motion sensor (7), a movement value characterizing movement of the base body (2);
determining a position of the hand protection device (6) relative to the base body (2), wherein the hand protection device (6) is movable between at least a far-from-the-tool position (31) and a close-to-the-tool position (32);
setting a threshold based on the determined position of the hand protection device (6), wherein the threshold has a first threshold value when the hand protection device (6) is in the far-from-the-tool position (31) and a second threshold value when the hand protection device (6) is in the close-to-the-tool position (32), the second threshold value being less than the first threshold value; and
braking the motor (4) and/or the tool (3) when the movement value exceeds the threshold.
